(19) United States
(12) Patent Application Publication
(10) Pub. No.: US 2025/0134747 A1
(43) Pub. Date: May 1, 2025

(54) GAIT ASSISTANCE MECHANISM

(71) Applicants: SEOUL NATIONAL UNIVERSITY R&DB FOUNDATION, Seoul (KR); SEOUL NATIONAL UNIVERSITY HOSPITAL, Seoul (KR)

(72) Inventors: Jae Heung PARK, Seoul (KR); Seung Bin YOU, Seoul (KR); Eun Ho SUNG, Seoul (KR); Kee Won KIM, Seoul (KR); Sun Gun CHUNG, Seoul (KR)

(73) Assignees: SEOUL NATIONAL UNIVERSITY R&DB FOUNDATION, Seoul (KR); SEOUL NATIONAL UNIVERSITY HOSPITAL, Seoul (KR)

(21) Appl. No.: 18/931,442

(22) Filed: Oct. 30, 2024

(30) Foreign Application Priority Data
Oct. 31, 2023 (KR) 10-2023-0147565

(51) Int. Cl. A61H 3/00

(52) U.S. Cl. CPC A61H 3/00; A61H 2003/007; A61H 2201/1253; A61H 2201/1638; A61H 2203/0406

(57) ABSTRACT

The gait assistance mechanism according to one example of the present invention may comprise one or more tendons connecting an upper limb, a trunk, and a lower limb of a wearer and a fixing part fixing the one or more tendons to the body of the wearer, and the one or more tendons may comprise a driving tendon connecting the lower limb and the upper limb on the same side of the wearer.

### TECHNICAL FIELD

The present invention relates to a gait assistance mechanism, and more specifically, relates to a gait assistance mechanism that can assist a gait of a user with insufficient muscle strength.

### BACKGROUND ART

Walking is the most important movement of daily life, and it is well known that maintaining independent daily living ability is closely related to quality of life, and the mortality rate significantly differs according to whether the walking function is maintained.

However, most of the conventionally existing technologies have great limitations as FIG. 1, the conventional gait assistance robots as the example shown in (a) of FIG. 1 are mostly rigid exoskeleton types, which are heavy and expensive, so the general public has difficulty in easy access, and they restrictively mimic the mechanical degree of freedom of the robots only for the sagittal plane movements of the lower limb, so they are different from the natural gait of ordinary people. Gait assistance devices, which are other rehabilitation tools such as the example shown in (b) of FIG. 1 have clear limitations in that they can partially support body weight such as canes, walkers and the like, but cannot assist in movements that create gait patterns by themselves, and as same as in the case of reciprocating gait orthosis (RGO), the load supporting level irrelevant to natural gait is a mere primary role.

### DISCLOSURE

### Technical Problem

The present invention is to solve the afore-mentioned problems of the prior arts, and relates to a gait assistance mechanism which can assist gait of a wearer who has difficulty in normal gait by himself because of insufficient lower limb muscle strength due to the aged, sarcopenia or other different causes.

However, the problems to be solved by the examples of the present invention are not limited to the afore-mentioned problems, and can be expanded in various ways within the scope of the technical spirit included in the present invention.

### Technical Solution

In order to achieve the objects, the gait assistance mechanism according to one example of the present invention may comprise one or more tendons connecting an upper limb, a trunk, and a lower limb of a wearer; and a fixing part fixing the one or more tendons to the body of the wearer, and the one or more tendons may comprise a driving tendon connecting a lower limb and an upper limb on the same side of the wearer.

The driving tendon may generate movement about at least one axis among the ankle, knee and hip in the sagittal plane of the wearer.

The driving tendon may comprise a first driving tendon connecting to a lower limb on one side and an upper limb on one side of the wearer, and a second driving tendon connecting to a lower limb on the other side and an upper limb on the other side of the wearer.

The first driving tendon and the second driving tendon may be fixed to the body of the wearer so that extension movement of a lower limb on one side and an upper limb on the other side of the wearer and flexion movement of a lower limb on the other side and an upper limb on one side are performed simultaneously.

The first driving tendon may cause extension movement of the hip, extension movement of the knee and plantar flexion movement of the ankle in the lower limb on one side of the wearer, and the second driving tendon may cause flexion movement of the hip, flexion movement of the knee, and dorsi flexion movement of the ankle in the lower limb on the other side of the wearer.

The gait assistance mechanism may further comprise a spacer to space the driving tendon from a calcaneus of the ankle, a patella of the knee, and a greater trochanter of the pelvis of the wearer by a predetermined distance.

The spacer may be a pulley.

The gait assistance mechanism may further comprise a torque increasing member connecting to the driving tendon between the upper limb and the trunk of the wearer and increasing torque delivered from the upper limb to the lower limb.

The torque increasing member may be a movable pulley, a reducer, or a combination thereof.

The driving tendon may be fixed to the body of the wearer to support the rear of the thigh, the front of the knee, and the rear of the calf of the wearer.

The one or more tendons may be fixed on the distal part of the lower limb.

The gait assistance mechanism may further comprise a frame part fixing the distal part of the lower limb, and a fixing part fixing the one or more tendons in the distal part may be formed on the frame part.

The gait assistance mechanism may further comprise an energy storage member which is positioned on the ankle joint or above the ankle joint of the wearer and is connected to the driving tendon, and stores energy of the driving tendon, and the force transmission from the distal part of the lower limb through the driving tendon may be delayed by the energy storage member.

The energy storage member may be an elastic member.

The gait assistance mechanism may further comprise a bar member supporting a part of the body weight as handheld by the wearer, and the driving tendon may be connected to the bar member.

The one or more tendons may further comprise a rotating tendon connecting a lower limb and an upper limb on different sides from each other of the wearer.

The rotating tendon may generate movement of internal rotation of the pelvis of the wearer.

The rotating tendon may comprise a first rotating tendon connecting to a lower limb on the other side and an upper limb on one side of the wearer and a second rotating tendon connecting to a lower limb on one side and an upper limb on the other side of the wearer.

A bar member supporting a part of the body weight as handheld by the wearer may be further comprised, and the rotating tendon may be connected to the bar member.

The gait assistance mechanism may further comprise a wearable suit, and the fixing part may fix the one or more tendons on the wearable suit.

The wearable suit may comprise a knee wearing part formed to cover the front and rear of the knee of the wearer, and an opening part may be formed in the part corresponding to the patella of the front of the knee in the knee wearing part, and the one or more tendons may be arranged so as not to pass through the opening part.

### Advantageous Effects

The gait assistance mechanism according to the examples of the present invention primarily enables a person who cannot even sufficiently generate anti-gravity torque due to insufficient muscle strength to stand up on his own. In addition, the gait assistance mechanism according to the example of the present invention can create gait movement that cannot be created by conventional gait assistance robots or gait assistance devices, thereby assisting gait of a patient who could not walk on his own.

In particular, the gait assistance mechanism according to the examples of the present invention can create gait movement of a lower body by using only the force of the upper body without an external power source.

The effects of the present invention are not limited to the effects mentioned above, and other effects not mentioned can be clearly understood by those skilled in the art from the description of claims.

### BRIEF DESCRIPTION OF THE DRAWINGS

FIG. 1 is a drawing that shows an example of a conventional gait assistance robot.

FIG. 2 is a drawing that illustratively shows the gait assistance mechanism according to one example of the present invention.

FIG. 3 is a side view of the gait assistance mechanism illustrated in FIG. 2.

FIG. 4 is a drawing to describe one example in which the driving tendon of the gait assistance mechanism according to one example of the present invention is fixed to the lower limb of a wearer.

FIG. 5 is a drawing to describe a section for assisting thrust during walking.

FIG. 6 is a side view to describe the spacer of the gait assistance mechanism according to one example of the present invention.

FIG. 7 is a drawing to describe the torque increasing member of the gait assistance mechanism according to one example of the present invention.

FIG. 8 and FIG. 9 are drawings which show examples of the energy member of the gait assistance mechanism according to one example of the present invention storing and consuming energy according to the wearer's gait.

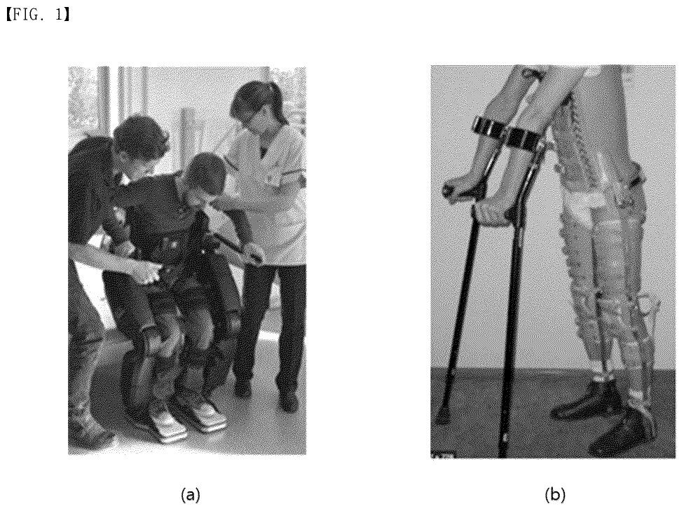

### MODE FOR INVENTION

Hereinafter, with reference to the attached drawings, various examples of the present invention will be described in detail so that those skilled in the art can easily implement it. The present invention may be implemented in various different forms, and is not limited to the examples described herein.

In order to clearly describe the present invention, parts irrelevant to the description are omitted, and the same reference symbols are used for identical or similar components throughout the entire description.

In addition, the size and thickness of each component shown in the drawings are arbitrarily shown for convenience of description, so the present invention is not necessarily limited to what is shown. In the drawings, in order to clearly express various layers and regions, the thickness is shown in an enlarged manner. In addition, in the drawings, for convenience of description, the thickness of some layers and regions is exaggeratedly shown.

In addition, when a part such as a layer, membrane, region, plate, or the like is said to be “above” or “on” another part, this includes not only cases where it is “directly above” another part, but also cases where there is another part in between. Conversely, when a part is said to be “directly above” another part, it means that there is no other part in between. In addition, when it is said to be “above” or “on” the reference part, it means that it is located above or below the reference part, and it does not necessarily mean that it is located “above” or “on” it in the opposite direction of gravity.

In addition, throughout the description, when a certain part is said to “comprise” a certain component, this does not mean excluding other components, but mean comprising other components additionally, unless otherwise specifically mentioned.

Furthermore, throughout the description, when it is said to be “planar”, this means when a target part is viewed from above, and when it is said to be “cross-sectional”, this means when a cross-section cut vertically of a target part is viewed from the side.

In addition, throughout the description, “sagittal plane” means a plane parallel to the median plane that divides the human body in bilateral symmetry, and “coronal plane” means a plane parallel to the plane that divides the human body into ventral and dorsal parts, and “axial plane” means a plane that is perpendicular to the sagittal plane and coronal plane, and is generally a horizontal plane.

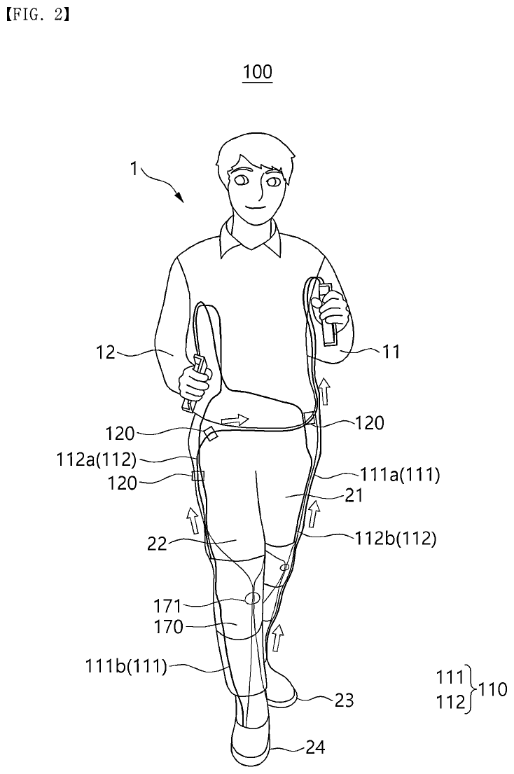

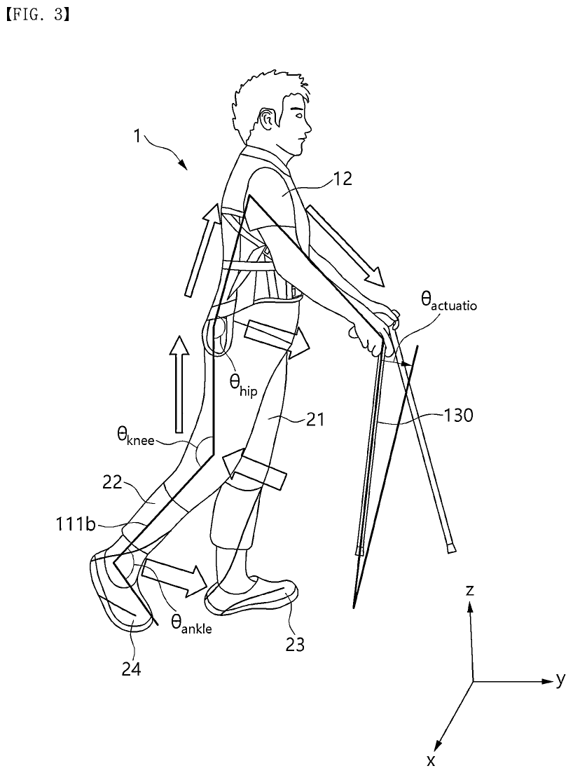

FIG. 2 is a drawing that illustratively shows the gait assistance mechanism according to one example of the present invention. FIG. 3 is a side view of the gait assistance mechanism illustrated in FIG. 2.

Human locomotion such as walking and driving and the like has been developed and implemented through complementary movement of upper limbs and lower limbs, and left limbs and right limbs, including the trunk and limbs. In order to assist the physiological motor pattern through the tendon driving method, complementary movements of the trunk and limbs should be implemented so that such a whole-body motor pattern can be simulated. The gait assistance mechanism (100) according to the examples of the present invention is a mechanism which assists walking or driving motions based on such biological characteristics.

Referring to FIG. 2 and FIG. 3, the gait assistance mechanism (100) may comprise one or more tendons (110) connecting an upper limb, a trunk, and a lower limb of a wearer (1); and a fixing part (120) fixing the one or more tendons (110) to the body of the wearer (1). The one or more tendons (110) may comprise a driving tendon (111) connecting a lower limb and an upper limb on the same side of the wearer (1). In addition, the one or more tendons (110) may further comprise a rotating tendon (112) connecting a lower limb and an upper limb on different sides from each other of the wearer (1).

Then, the driving tendon (111) may generate movement about at least one pitch axis among the ankle, knee and hip in the sagittal plane of the wearer (1).

The gait assistance mechanism (100) assists upper limbs with muscle strength required for sagittal motion movements during the single support push phase accounting for most of the muscle strength required for walking. For example, the sagittal motion includes movements of hip extension, knee extension, and ankle plantar flexion.

The gait assistance mechanism (100) enables the wearer (1) to maintain walking by his own power without any external power or actuator. The gait assistance mechanism (100) may create a driving force for walking by connecting movements of three pitch axes in the sagittal plane of hip extension, knee extension and ankle plantar flexion through the driving tendon (111). Such reciprocal motion between the left/right, and upper limbs/lower limbs may be created in the sagittal plane through the gait assistance mechanism (100) to assist walking/driving.

The driving tendon (111) may comprise a first driving tendon (111a) connecting to a lower limb (21) on one side and an upper limb (11) on one side of the wearer (1), and a second driving tendon (111b) connecting to a lower limb (22) on the other side and an upper limb (12) on the other side of the wearer. Specifically, the first driving tendon (111a) and the second driving tendon (111b) may be symmetrically connected to each of the lower limbs. Through this, by assisting the movements of the wearer (1), the wearer (1) wearing the gait assistance mechanism (100) may easily make running or walking movements.

The first driving tendon (111a) and the second driving tendon (111b) may be fixed to the body of the wearer (1) so that extension movement of a lower limb (21) on one side and an upper limb (12) on the other side of the wearer (1) and flexion movement of a lower limb (22) on the other side and an upper limb (11) on one side are performed simultaneously.

More specifically, the first driving tendon (111a) may cause extension movement of the hip, extension movement of the knee and plantar flexion movement of the ankle in the lower limb (21) on one side of the wearer (1), and the second driving tendon (111b) may cause flexion movement of the hip, flexion movement of the knee, and dorsi flexion movement of the ankle in the lower limb (22) on the other side of the wearer (1).

On the other hand, for convenience of description, in FIG. 2, the left side of the wearer (1) is expressed as one side, and the right side is expressed as the other side, but they are not limited as mentioned above. In other words, when any one of the left side or right side of the wearer (1) is expressed as one side, the other one may be expressed as the other side. Therefore, the extension movement or flexion movement by the afore-mentioned first driving tendon (111a) and second driving tendon (111b) may occur on either the left side or right side of the wearer (1).

The gait assistance mechanism (100) according to one example of the present invention may comprise a rotating tendon (112) for axial motion. The rotating tendon (112) creates axial motion, thereby assisting movement of the pelvic internal rotation of the wearer (1), which occurs during gait motions. The rotating tendon (112) assists the rotational movement of the trunk of the wearer (1) on the axial plane so that the rotational movement of the trunk of the wearer (1) on the axial plane is harmonized with the gait motion.

As one example, the rotating tendon (112) may comprise a first rotating tendon (112) connecting to a lower limb (22) on the other side and an upper limb (11) on one side of the wearer (1) and a second rotating tendon (112) connecting to a lower limb (21) on one side and an upper limb (12) on the other side of the wearer.

As mentioned above, the driving tendon (111) assists movement on the pitch axial plane of the sagittal plant of the wearer (1). Then, approximating the axial motion in which pelvic rotation is added through the rotating tendon (112) can help gait of the wearer (1) a lot. The rotating tendon (112) also assists upper limbs with the power required for pelvic rotation of the wearer (1) similarly to the driving tendon (111).

The gait assistance mechanism (100) may further comprise a bar member (130) supporting a part of the body weight as handheld by the wearer (1). The bar member (130) may be for example, a member having a shape extending to one side from a part handheld by the wearer (1) such as a cane, a pole, and the like.

The driving tendon (111) and the rotating tendon (112) may be connected to the bar member (130) extended from an upper limb of the wearer (1). In this case, the wearer (1) can walk in a manner in which the one or more tendons (110) are pulled together, while supporting his body weight on the bar member (130). Gait by the bar member (130) may have a great effect in assisting gait in patients with seriously insufficient muscle strength.

On the other hand, the one or more tendons (110) may be fixed on the distal parts (23, 24) of the lower limbs. For example, the distal parts of the lower limbs may be tips of feet of the wearer (1).

Each tendon (110) operates by connecting several joints in series. At this time, when it is not properly connected to the final distal parts (23, 24), it may cause pain and damage to other parts of the body. For example, when the gait assistance mechanism (100) assists motions only at the heel, deformation of the sole and damage to the plantar fascia may be concerned.

Therefore, in one example of the present invention, each tendon (110) is completely connected to the distal parts (23, 24) of lower limbs to deliver power, and it is designed to deliver power to the distal parts (23, 24) completely, to prevent damage of other body parts.

In addition, the gait assistance mechanism (110) may further comprise a frame part (not shown) fixing the distal parts (23, 24) of the lower limb. A fixing part fixing the one or more tendons (110) in the distal parts (23, 24) may be formed on the frame part. The frame part may be a rigid member such as metal, plastic or the like. Since the body is fixed by the rigid frame part in the distal parts (23, 24) of the wearer (1), damage to other body parts of the wearer may be prevented.

On the other hand, the one or more tendons (110) may be connected to one part of an upper limb of the wearer (1) in necessary, and for example, the one or more tendons (110) may be connected to an upper arm, shoulder, elbow, or the like of the wearer (1) if necessary, and moreover, it may be connected to the bar member (130) extended from the upper limb.

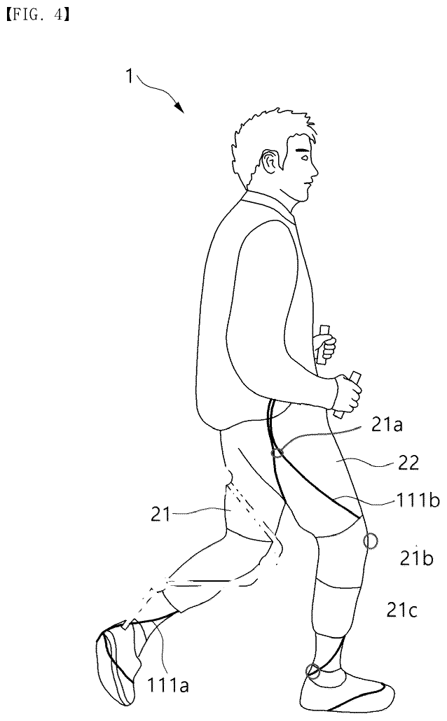

FIG. 4 is a drawing to describe one example in which the driving tendon of the gait assistance mechanism according to one example of the present invention is fixed to the lower limb of a wearer.

Referring to FIG. 4, the driving tendon (111) may be fixed to the body of the wearer (1) to support the rear of the thigh (21a), the front of the knee (21b), and the rear of the calf (21c) of the wearer (1).

The driving tendon (111) can transmit power using the rear of the calf (23a) and the rear of the thigh (21a) based on the knee cap bon of the lower limb of the wearer (1) as supporting points, so flexion and extension of joints can be effectively operated, and thereby, during walking, intended extension movements can be created more effectively.

On the other hand, in FIGS. 2 to 4, for convenience of description, there are cases of describing the configuration of the gait assistance mechanism (100), based on any one side of one side and the other side of the wearer (1), but this is merely for convenience of description, and also in the other side, the configuration of the gait assistance mechanism (100) may be symmetrically applied.

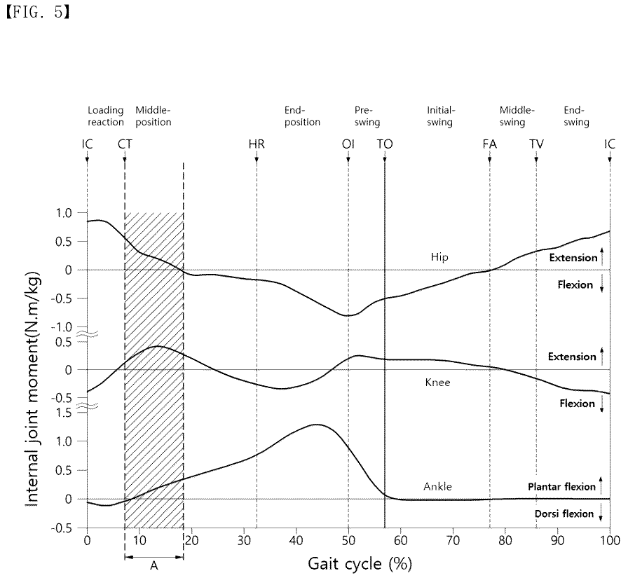

FIG. 5 is a drawing to describe a section for assisting thrust during walking.

Referring to FIG. 5, general gait requires internal torque as shown in each section based on one cycle. In the section marked A in the drawing, torque occurs simultaneously in the direction of hip extension, knee extension and ankle plantar flexion. The gait assistance mechanism (100) according to the examples of the present invention may create natural gait, as it assists the thrust during walking by pulling at the one or more tendons (110).

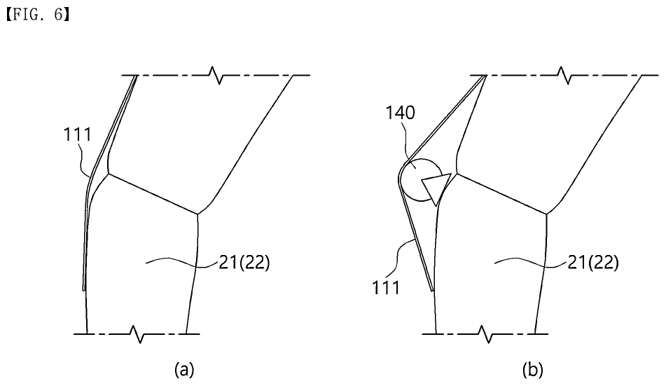

FIG. 6 is a side view to describe the spacer of the gait assistance mechanism according to one example of the present invention.

Referring to FIG. 6, the gait assistance mechanism (100) may comprise a spacer (140) to space the driving tendon (111) from a calcaneus of the ankle, a patella of the knee, and a greater trochanter of the pelvis of the wearer (1) by a predetermined distance.

In the actual human body, muscle is driven based on tendons. In order to maximize power in this method, a method of increasing the size of the lever arm may be considered. In the human body, a greater trochanter in the calcaneus in the heel and the patella and pelvis in the knee plays such a role. Also, in the gait assistance mechanism (100) according to one example of the present invention, such a principle is applied as it is, to increase assistive torque at a specific joint.

In the case of (a) of FIG. 6, it is an example of illustrating a case where the gait assistance mechanism (100) does not comprise the spacer (140), and in the case of (b) of FIG. 6, it is an example of illustrating a case where the gait assistance mechanism (100) comprises the spacer (140). As (b) of FIG. 6, when the lever arm is raised using the spacer (140), the assistive force applied to each joint may be greatly increased.

At this time, the spacer (140) may be a pulley, but is not limited to the mentioned above, and any configuration which can increase the assistive torque at a joint by supporting the one or more tendons (110) spaced by a predetermined distance from the body of the wearer (1) may be included in the example of the present invention.

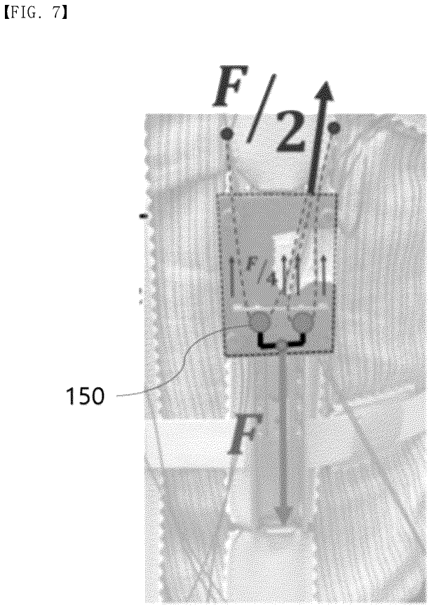

FIG. 7 is a drawing to describe the torque increasing member of the gait assistance mechanism according to one example of the present invention.

Referring to FIG. 7, the gait assistance mechanism (100) may further comprise a torque increasing member (150) connecting to the driving tendon (111) between the upper limb and the trunk of the wearer (1) and increasing torque delivered from the upper limb to the lower limb. In general, the power of the human lower limb is stronger than the power of the upper limb, so such a difference in power may be supplemented by the torque increasing member (150).

As shown in FIG. 7, the torque increasing member (150) may decrease the power required in the upper limb of the wearer (1). Through this, it is possible to supplement the difference in power of the upper limb and lower limb.

In the present invention, the mounting position of the torque increasing member is not particularly limited, but the torque increasing member (150) may be a structure to be mounted on the waist in one example, and it may be a structure to be mounted on the shoulder part in another example.

The torque increasing member (150) may be for example, a movable pulley, a reducer, or a combination thereof. However, the torque increasing member (150) is not limited to the mentioned above, and any case where the power of the upper limb can be supplemented may be included in the examples of the present invention.

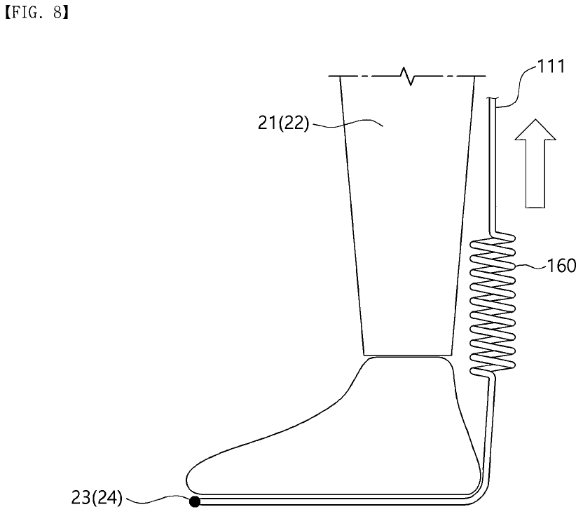

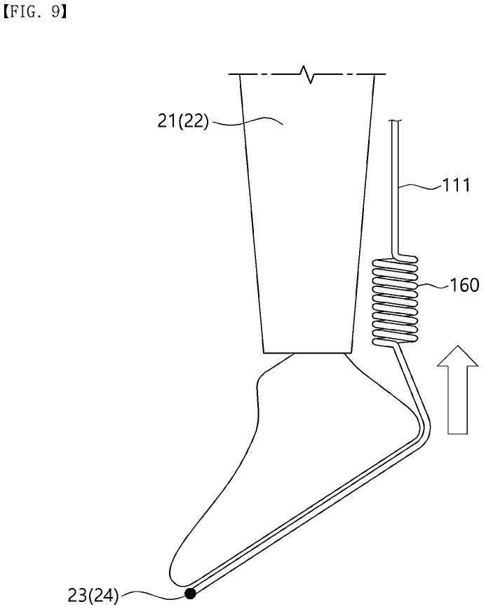

FIG. 8 and FIG. 9 are drawings which show examples of the energy member of the gait assistance mechanism according to one example of the present invention storing and consuming energy according to the wearer's gait.

Referring to FIG. 8 and FIG. 9, the gait assistance mechanism (100) may comprise an energy storage member (160) which is positioned on the ankle joint or above the ankle joint of the wearer (1) and is connected to the driving tendon (111), and stores energy of the driving tendon (111). The force transmission through the driving tendon (111) from the distal part of the lower limb may be delayed by the energy storage member (160).

In the case of natural gait, the extension phase of the ankle is slightly later than that of the hip and knee. Therefore, in order to more naturally assist the gait of the wearer (1), the gait assistance mechanism (100) may comprise a phase conversion mechanism of the ankle joint. As the examples illustrated in FIG. 8 and FIG. 9, when the energy storage member (160) is added to the ankle joint or above the ankle joint, the driving tendon (111) of the ankle joint is pulled up later than the driving tendon (111) of the hip and knee by the energy storage member (160).

The energy storage member (160) may be an elastic member. By appropriately adjusting the stiffness of the elastic member, phase lagging that matches the natural gait speed of the wearer (1) may be mechanically created. In the example shown in FIG. 8, an example in which energy is stored in the energy storage member (160) is illustrated, and in the example shown in FIG. 9, an example in which the energy stored in the energy storage member (160) is consumed is illustrated. In other words, the energy storage member (160) may create phase lagging through storage and consumption of energy transmitted through the driving tendon (111).

However, the type of the energy storage member (160) is not limited to the mentioned above, and if phase lagging can be mechanically created at the ankle part of the wearer (1), it may be included in the examples of the present invention. For example, even if a cam or the like is utilized, the same effect as the elastic member may be expected.

In addition, the gait assistance mechanism (100) may comprise a wearable suit (not shown). The one or more tendons (110) connect the upper limb, trunk and lower limb of the wearer (1) by the wearable suit. In other words, the fixing part (120) may fix the one or more tendons (110) to the wearable suit, and as the wearer (1) wears the wearable suit, the one or more tendons (110) fixed to the wearable suit are fixed to the body of the wearer (1).

For example, the wearable suit may be provided in a form of clothing that can be worn by the wearer (1) or can be worn on a specific body part. However, the wearable suit is not limited to the mentioned above, and the wearable suit may be provided in various forms that can be worn by the wearer (1).

Referring to FIG. 2 again, the wearable suit may comprise a knee wearing part (170) formed to cover the front and rear of the knee of the wearer. Then, in the knee wearing part (170), an opening part (171) may be formed in a part corresponding to the patella of the knee front.

In the case of the knee, when the patella which is a knee cap bone is directly pressed, there is a risk of injury to the knee. If the tendon (110) passes through the knee, the pressure of the patella-femoral joint increases, and accordingly, it may cause injury to the joint. To prevent this, by forming an opening part (171) in the knee wearing part (170), it may be arranged so that the tendon (110) does not pass through the opening part (171).

The gait assistance mechanism (100) mentioned hereby can be used for patients who have difficulty in normal walking on their own because of insufficient muscle strength due to the aged, sarcopenia, or other causes. However, it is not limited thereto, and it can be used for ordinary people with normal muscle strength as a mechanism for assisting muscle strength during movements in which extension movements of the hip and knee are generated a lot such as mountain climbing, stairs, squats, and the like.

The preferable examples of the present invention have been described in detail above, but the scope of the present invention is not limited thereto, and various modified and improved forms by those skilled in the art using the basic concepts of the present invention defined in the following claims also fall within the scope of the present invention.

### DESCRIPTION OF THE SYMBOLS

1: Wearer
11, 12: Upper limbs
21, 22: Lower limbs
23, 24: Distal parts
100: Gait assistance mechanism
110: One or more tendons
111 (111a, 111b): Driving tendon
112 (112a, 112b): Rotating tendon
120: Fixing part
130: Bar member
140: Spacer
150: Torque increasing member
160: Energy storage member
170: Knee wearing part
171: Opening part

1. A gait assistance mechanism, comprising one or more tendons connecting an upper limb, a trunk, and a lower limb of a wearer; and
a fixing part fixing the one or more tendons to the body of the wearer,
wherein the one or more tendons comprise a driving tendon connecting a lower limb and an upper limb on the same side of the wearer.

2. The gait assistance mechanism according to claim 1,
wherein the driving tendon generates movement about at least one axis among the ankle, knee and hip in the sagittal plane of the wearer.

3. The gait assistance mechanism according to claim 2,
wherein the driving tendon comprises a first driving tendon connecting to a lower limb on one side and an upper limb on one side of the wearer, and a second driving tendon connecting to a lower limb on the other side and an upper limb on the other side of the wearer.

4. The gait assistance mechanism according to claim 3,
wherein the first driving tendon and the second driving tendon are fixed to the body of the wearer so that extension movement of a lower limb on one side and an upper limb on the other side of the wearer and flexion movement of a lower limb on the other side and an upper limb on one side are performed simultaneously.

5. The gait assistance mechanism according to claim 3,
wherein the first driving tendon causes extension movement of the hip, extension movement of the knee and plantar flexion movement of the ankle in the lower limb on one side of the wearer, and
the second driving tendon causes flexion movement of the hip, flexion movement of the knee, and dorsi flexion movement of the ankle in the lower limb on the other side of the wearer.

6. The gait assistance mechanism according to claim 2,
further comprising a spacer to space the driving tendon from a calcaneus of the ankle, a patella of the knee, and a greater trochanter of the pelvis of the wearer by a predetermined distance.

7. The gait assistance mechanism according to claim 6,
wherein the spacer is a pulley.

8. The gait assistance mechanism according to claim 1,
further comprising a torque increasing member connecting to the driving tendon between the upper limb and the trunk of the wearer and increasing torque delivered from the upper limb to the lower limb.

9. The gait assistance mechanism according to claim 8,
wherein the torque increasing member is a movable pulley, a reducer, or a combination thereof.

10. The gait assistance mechanism according to claim 1,
wherein the driving tendon is fixed to the body of the wearer to support the rear of the thigh, the front of the knee, and the rear of the calf of the wearer.

11. The gait assistance mechanism according to claim 1,
wherein the one or more tendons are fixed on the distal part of the lower limb.

12. The gait assistance mechanism according to claim 1,
further comprising a frame part fixing the distal part of the lower limb,
wherein a fixing part fixing the one or more tendons in the distal part is formed on the frame part.

13. The gait assistance mechanism according to claim 12,
further comprising an energy storage member which is positioned on the ankle joint or above the ankle joint of the wearer and is connected to the driving tendon, and stores energy of the driving tendon,
wherein the force transmission from the distal part of the lower limb through the driving tendon is delayed by the energy storage member.

14. The gait assistance mechanism according to claim 13,
wherein the energy storage member is an elastic member.

15. The gait assistance mechanism according to claim 1,
further comprising a bar member supporting a part of the body weight as handheld by the wearer,
wherein the driving tendon is connected to the bar member.

16. The gait assistance mechanism according to claim 1,
wherein the one or more tendons further comprise a rotating tendon connecting a lower limb and an upper limb on different sides from each other of the wearer.

17. The gait assistance mechanism according to claim 16,
wherein the rotating tendon generates movement of internal rotation of the pelvis of the wearer.

18. The gait assistance mechanism according to claim 17,
wherein the rotating tendon comprises a first rotating tendon connecting to a lower limb on the other side and an upper limb on one side of the wearer and a second rotating tendon connecting to a lower limb on one side and an upper limb on the other side of the wearer.

19. The gait assistance mechanism according to claim 16,
further comprising a bar member supporting a part of the body weight as handheld by the wearer,
wherein the rotating tendon is connected to the bar member.

20. The gait assistance mechanism according to claim 1,
further comprising a wearable suit,
wherein the fixing part fixes the one or more tendons on the wearable suit.

21. The gait assistance mechanism according to claim 20,
wherein the wearable suit comprises a knee wearing part formed to cover the front and rear of the knee of the wearer, and
an opening part is formed in the part corresponding to the patella of the front of the knee in the knee wearing part, and
the one or more tendons are arranged so as not to pass through the opening part.
